(19) United States
(12) Patent Application Publication
(10) Pub. No.: US 2003/0138189 A1
(43) Pub. Date: Jul. 24, 2003

(54) Optical cross-connect switch for high-bit-rate space-based communications

(76) Inventors: D. A. Rockwell, Culver City, CA (US); Anthony L. McKay, Long Beach, CA (US); Andrew L. Strodtbeck, MDR, CA (US)

Correspondence Address: Kevin G. Mierzwa, Artz & Artz, P.C., Suite 250, 28333 Telegraph Road, Southfield, MI, 48034, US

(21) Appl. No.: 10/054,581

(22) Filed: Jan. 22, 2002

(51) Int. Cl. G02B 6/26; G02B 6/28; G02B 6/35

(52) U.S. Cl. 385/15; 385/24; 385/16

(57) ABSTRACT

A router circuit has an electrical-to-optical converter for changing the plurality of electrical input signals into a plurality of optical input signals. A mixing circuit is coupled to the electrical-to-optical converter. The mixing circuit generates a plurality of substantially identical composite signals corresponding to the plurality of optical inputs. The composite signals comprise at least a portion of each of the plurality of optical signals. A plurality of optical bandpass filters is coupled, respectively, to each of said plurality of composite signals. The bandpass filters pass a portion of the composite optical signals to form a plurality of filtered signals. An optical-to-electrical converter is coupled to the plurality of bandpass filters. The optical-to-electrical converter converts the plurality of filtered optical signals into a respective plurality of electrical output signals.

### TECHNICAL FIELD

The present invention relates to a router circuit, and more particularly, to a router circuit for selectively routing communication signals for high-speed applications such as implementation on a satellite.

### BACKGROUND ART

Typically, cross-connecting router type circuits use microelectronics to route incoming signals to an appropriate output. Various types of switches, both mechanical and electrical, are employed. One drawback to such designs is that the circuits are typically relatively heavy and consume excess power. In many applications such as space applications, weight, size and power consumption requirements are a premium.

Space applications are also high frequency applications. Therefore, fast switching must be employed. Previously known microelectronic circuits often switch at greater than one microsecond as opposed to the several nanosecond switching times required in the high frequency space applications.

Another drawback to known routing circuits is that oftentimes mechanical switches are employed. Particularly in space-based applications where access to the devices for a failed component is not available, reliable non-mechanical switches are desirable. Another drawback to previously known systems is that high voltages must often be employed. High voltages are not desirable in many applications because of the tendency for arcing. Arcing circuits may cause damage to the surrounding electrical circuitry.

It would therefore be desirable to provide a routing circuit that reduces or eliminates the above-mentioned drawbacks.

### SUMMARY OF THE INVENTION

The present invention advantageously employs electrical and optical circuitry that allows the router circuit to route signals at high speeds with no moving mechanical parts.

In one aspect of the invention, a router circuit has an electrical-to-optical converter for changing a plurality of electrical input signals into a plurality of optical input signals. A mixing circuit is coupled to the electrical-to-optical converter. The mixing circuit generates a plurality of substantially identical composite optical signals corresponding to the plurality of optical inputs. The composite signals comprise at least a portion of each of the plurality of optical input signals. A plurality of optical bandpass filters is coupled, respectively, to each one of said plurality of composite signals. The bandpass filters pass a portion of the composite optical signals to form a plurality of filtered signals. An optical-to-electrical converter is coupled to the plurality of bandpass filters. The optical-to-electrical converter converts the plurality of filtered optical signals into a respective plurality of electrical output signals.

One feature of the present invention is that the mixing circuit may be formed using optical-fiber based passive star power splitters.

In a further aspect of the invention, a method for operating a routing circuit comprises:

converting a plurality of electrical signals to a respective plurality of modulated optical signals;

coupling the plurality of modulated optical signals to a cross-connect switch;

forming a plurality of composite signals at a plurality of outputs of the cross-connect switch, said plurality of composite signals composed of said modulated optical signals; and

converting at least one of the composite optical signals into an electrical output signal corresponding to a portion of said modulated optical signal.

One advantage of the invention is that fast switching times on the order of several nanoseconds may be achieved. This allows implementation in high-speed communication satellites or other high-speed applications. Another advantage of the invention is that no moving mechanical parts are required. The mixing circuitry may be implemented in passive star optical power splitters and therefore have no moving parts.

The present invention uses a tunable electrical-to-optical converter that can select the wavelength of each of the plurality of optical input channels. By selecting each wavelength to correspond to the center wavelength of the optical bandpass filter of the desired output channel, each of the optical signals is routed to the desired output channel.

Another advantage of the invention is that the electrical-to-optical converter may employ low voltages to control the tunable electrical-to-optical converters. Another advantage of the invention is that tunable semiconductor diode lasers may be employed as the electrical-to-optical converters. Semiconductor diode lasers are a mature technology and therefore have high reliability.

Other advantages and features of the present invention will become apparent when viewed in light of the detailed description of the preferred embodiment when taken in conjunction with the attached drawings and appended claims.

### BRIEF DESCRIPTION OF THE DRAWINGS

FIG. 1 is a perspective view of a satellite having a routing circuit according to the present invention.

FIG. 2 is a schematic view of a router circuit of the present invention.

FIG. 3 is a schematic view of the cross-connect switch of FIG. 2.

FIG. 4 is a schematic view of an alternative laser configuration according to the present invention.

### BEST MODES FOR CARRYING OUT THE INVENTION

In the following figures the same reference numerals will be used to illustrate the same components in the various views. While the present invention is illustrated with respect to a satellite communication system, the present invention may be employed in various types of communications systems including earth-based systems. The present invention is particularly suited for high-speed communication systems.

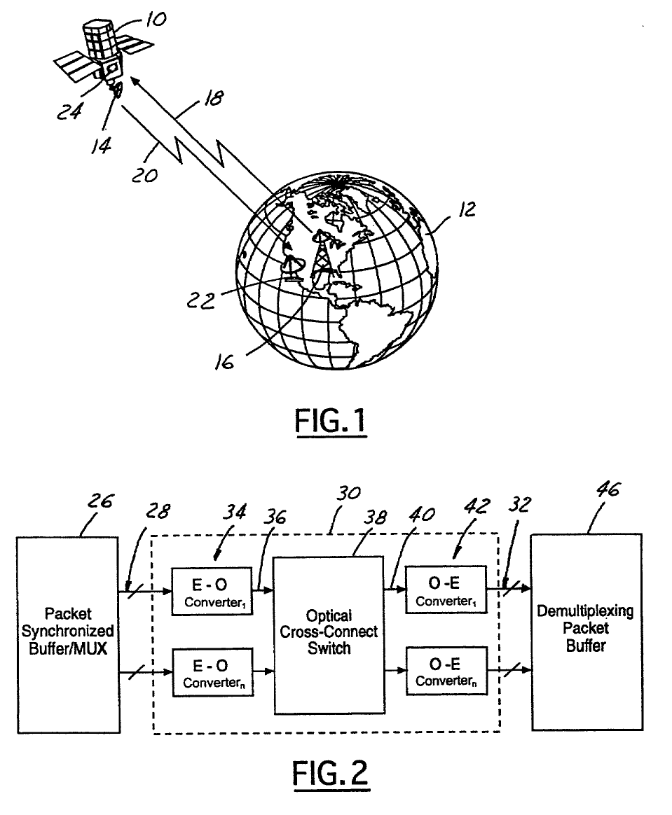

Referring now to FIG. 1, a satellite 10 is positioned above earth 12. Satellite 10 has an antenna system 14 for communicating with a ground station 16 positioned on the surface of the earth. Antenna 14 is used to receive uplinks 18 and transmit downlinks 20 to ground station 16 or users 22.

Satellite 10 has a router circuit 24 formed according to the present invention. Satellite 10 actually has a plurality of uplinks 18 and a plurality of downlinks 20 even though only one of each is illustrated for simplicity. Router circuit 24 receives uplinks 18 and routes the signal to any of a multiple of output ports for downlinking. Although the present application is shown for routing uplinks to downlinks, the present application may be used in other types of satellite systems such as intersatellite links or within a satellite for various types of sensors located on the satellite.

Referring now to FIG. 2, a router circuit 24 formed according to the present invention is illustrated in further detail. Router circuit 24, in this example, is particularly suited for high-speed satellite communications. Router circuit 24 includes a packet synchronized buffer/multiplexer 26 which receives signals, for example, from the uplink circuitry. The packet synchronized buffer/multiplexer generates a plurality of RF inputs 28 to a switching circuit 30. Although RF inputs are illustrated, various types of electrical inputs may also be employed. RF inputs 28 may also be referred to as channels. The present invention is applicable to various numbers of RF inputs. The present description, however, is illustrated with 16 inputs and 16 outputs. Switching circuit 30 has a plurality of RF outputs 32. Although not required, it is preferred that the number of RF outputs 32 correspond to the number of RF inputs 28.

Switching circuit 30 is used to route a particular RF input 28 to a particular RF output 32. During the course of operation of router circuit 24, the routing may be readily changed.

Switching circuit 30 has an input section comprising a plurality of electrical-to-optical converters 34 which convert the electrical RF inputs into optical signals. As will be further described below, preferably one electrical-to-optical conversion is provided for each of the RF inputs 28. The electrical-to-optical converters generate optical input signals 36.

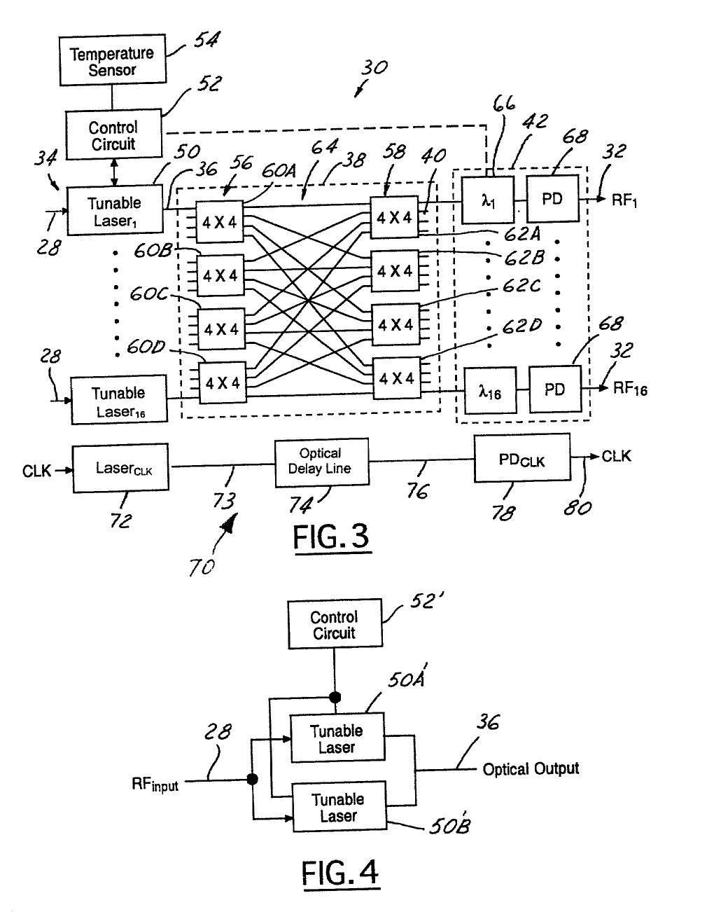

Switching circuit 30 has an optical cross-connect switch 38 therein. Optical cross-connect switch 38 receives optical signals 36 and forms composite optical signals 40. The configuration of optical cross-connect switch will be further described in FIG. 3 below. Preferably, one composite optical signal is provided for each optical input 36. The composite optical signals 40 have an optical portion corresponding to each of the input optical signals 36. Each of the signals 40 also contains input signal information that was originally contained on all of the RF inputs 28.

Switching circuit 30 has an output section comprising a plurality of optical-to-electrical converters 42 which convert the composite optical signals 40 into electrical outputs such as RF output 32. The content of RF output 32 is selected by optical-to-electrical converters 42. The signals from RF output 32 are coupled to a demultiplexing packet buffer 46. Demultiplexing packet buffer 46 changes signals from the electrical RF output 32 into a lower speed for electronic components and provides an elastic buffer which enables the electronic signals from the channels to be synchronized as they propagate to other circuitry.

In general, the electrical-to-optical converters 34 have a selectable wavelength and, by choosing the wavelength of the optical signals 36, the electrical-to-optical converter 34 may route the signal to a desired optical-to-electrical converter. Because the wavelength of the electrical-to-optical converter may be rapidly changed, the signal may be routed to the desired location at a high switch rate as will be further described below.

Referring now to FIG. 3, switching circuit 30 is illustrated in further detail. Electrical-to-optical converters 34 are preferably formed of modulated tunable lasers 50 as illustrated. For example, a semiconductor diode laser having a wavelength that can be rapidly tuned over a relatively broad spectral range of about 40 nanometers is preferred. A suitable tunable laser is manufactured by Agility Communications of Santa Barbara, California. Preferably, one tunable laser 34 is provided for each of the input channels or RF inputs 28. The use of tunable diode lasers to select the wavelength of the optical input signals 36 is simple and easy to control. The use of such lasers is therefore superior to previous approaches whereby a nonlinear optical process (four-wave mixing) in a semiconductor optical amplifier is employed to achieve conversion of an initial optical wavelength to the desired wavelength.

Each diode laser may be modulated by the incoming RF signal to produce an amplitude-modulated or on-off keyed (OOK) signal. However, other modulation approaches may also be applied including frequency, phase and pulse-position modulation.

As is known in the art, a common challenge with router schemes is to avoid cross-talk among adjacent channels. In the present invention, cross-talk can arise from imperfect control of the wavelength of the tunable diode lasers. For this reason, the present invention employs a control circuit 52 to control the operation of tunable lasers 50. Control circuit 52 may have a temperature sensor 54 coupled thereto, in which case control circuit 52 may apply a electronic wavelength-stabilization signal to the tunable lasers 34 in response to a temperature signal generated by temperature sensor 54. This approach for mitigating thermally induced wavelength drifts is preferable to the approach used in previously known systems, where thermoelectric coolers were used to control the temperature and thereby the wavelength of the tunable lasers. The thermoelectric coolers are expensive, they require appreciable input power for operation, and they represent a reliability risk.

Tunable lasers 50 are coupled to optical cross-connect switch 38. Optical cross-connect switch 38 has a first passive star power splitter section 56 coupled to a second passive star power splitter section 58. As mentioned above, the present example uses 16 RF input channels and 16 RF output channels. In this manner, 4×4 star power splitters 60A, 60B, 60C and 60D are illustrated. Second star power splitter section 58 has four 4×4 star power splitters 62A, 62B, 62C and 62D. As mentioned above with respect to FIG. 2, the composite output signals 40 from star power splitters 62A-62D contain a wavelength portion corresponding to each tunable laser 50. First star power splitter section 56 has each of the star power splitters 60A-60B coupled to tunable lasers 50. In this example, the first four tunable lasers are coupled to star power splitter 60A, the second four are coupled to star power splitter 60B, the third four are coupled to star power splitter 60C, and the last four are coupled to star power splitter 60D. Star power splitters 60A-60D generate intermediate composite signals 64. That is, each star power splitter generates intermediate composite signals comprising the four tunable lasers to which it is coupled. For example, each output of star power splitter 60A comprises a summation of all of the wavelengths of the first four tunable lasers. The four output signals of star power splitter 60A are identical. Star power splitter 60B forms intermediate composite signals 64 that correspond to the second four tunable lasers and so on. Each one of the four outputs of star power splitters 60A-60B is coupled to a respective one of the four inputs of the star power splitters 62A, 62B, 62C and 62D. In a similar manner to the way in which star power splitter 60A functions, star power splitter 62A also forms composite signals 40. Composite signals 40 comprise each of the wavelengths of all of the tunable lasers by adding the outputs of all of the four star power splitters 60A-60D.

Star power splitters 62A-62D are coupled to optical-to-electrical output section 42, which comprises a plurality of optical bandpass filters 66 which are tuned to allow one of the wavelengths of tunable lasers 50 therethrough. The tuned wavelength is referred to as the center wavelength of the optical bandpass filter 66. One bandpass filter 66 is provided for each of the four outputs of each of the four star power splitters 62A-62D.

Each bandpass filter 66 is coupled to a photodiode 68. Photodiode 68 is responsive to the optical signal and generates an electrical output in response thereto. In this example, electrical output of photodiode 68 is an RF output. The RF output 32 of photodiode 68 may be coupled to demultiplexing packet buffer 46 as described in FIG. 2 to allow the signals to be synchronized in time.

In addition to the information channels such as the RF inputs 28, a clock circuit 70 may also be provided. Clock circuit 70 also has a laser 72 which is coupled to an optical delay line 74. The optical delay line 74 may be an optical fiber. By routing the clock signal through an optical delay line 74 such as the optical fiber, the same time delay may be present in the clock circuit as in the composite output signals. The optical clock signal 73 is delayed through optical delay line 74 and generates a delayed clock signal 76. Delayed optical clock signal is coupled to a photodiode 78. Thus, the reconstructed clock signal 80 has the same time delay as the RF outputs 32 and can thus be used in the further processing circuit to allow synchronization of the RF outputs.

In operation, the tunable lasers 50 are tuned to a wavelength by control circuit 52 to match the center wavelength of one of the optical bandpass filters 66. For example, if the RF input channel 1 is to be coupled to the seventh output port, the wavelength of the first tunable laser is selected to match the bandpass filter center wavelength of the seventh output port. All of the signals from each of the tunable lasers end up at the seventh bandpass filter, however, only the selected optical wavelength passes through to the corresponding photodiode 68.

One feature of the present invention is that more than one tunable laser can be tuned to the same wavelength. This feature allows multiple input signals to pass through a single optical bandpass filter and thereby couple to the single output port corresponding to that bandpass filter. As those skilled in the art will recognize, attention must be paid to the relative timing of the signals to avoid any “collisions” between the multiple signals passing through the same filter.

One alternative embodiment of the present invention is providing a selectable bandpass filter 66. Bandpass filter 66 may be made selectable in a variety of manners. Control circuit 52 may be used to change the center wavelength of the bandpass filter 66. This alternative embodiment allows more than one filter to be tuned to the same wavelength and thereby allows individual input signals to couple to multiple output ports.

Referring now to FIG. 4, an alternative embodiment for tunable lasers 50 illustrated from that of FIG. 3. In this embodiment, two tunable lasers 50′A and 50′B are provided in place of each of the tunable lasers 50 in FIG. 3. This situation is suitable for applications in which the wavelength switching time for a single tunable laser is too long. In this manner, each tunable laser 50′A and 50′B may be selected by control circuit 52′ in a “ping-pong” approach. While one laser is operating, the other laser tunes to the correct wavelength for use after the next switching event.

Advantageously, the present invention eliminates the potential of thermally induced wavelength changes without requiring the use of a thermoelectric cooler. Thermoelectric coolers are presently used in many diode laser applications in space to control the temperature and hence the wavelength. However, as was mentioned earlier, thermoelectric coolers are expensive, they require appreciable input power for operation, and they represent a reliability risk.

One approach whereby the present invention eliminates problems associated with thermally induced wavelength changes is by preferably specifying a sufficiently wide wavelength spacing between channels that thermally induced wavelength changes do not exceed the channel spacing. For example, in space-based applications, a payload may experience approximately 50 degrees centigrade temperature change and the wavelength temperature coefficient is 0.1 nanometers per degree centigrade. Therefore, the wavelength change during a mission may be as much as 5 nanometers. If adjacent channels are spaced by more than 5 nanometers, the thermally induced wavelength changes can be accommodated without encountering excessive cross-talk among adjacent channels.

In applications requiring channels with closely spaced wavelengths, control circuit 52 may use a temperature sensor 54 to monitor the temperature and then simply adjust the wavelength-control current to maintain the desired wavelength of the tunable diode lasers despite the change in the temperature. The 5 nanometer wavelength control range required to accommodate a 50 degree centigrade temperature change is well within the tuning capabilities of 30 to 40 nanometers possible in current-tunable lasers. Note that this form of wavelength control functions without controlling the temperature of the diode lasers.

Another aspect of the invention is that control circuit 52 is preferably a closed loop system. That is, the wavelength tuning of the tunable lasers is monitored to prevent cross talk among adjacent channels. Control circuit 52 will switch the tunable lasers to the desired wavelength and let them stabilize before optical information signals are passed therethrough.

Another aspect of the invention is that synchronization among the output signals is provided. The packet buffer 26 at the input of the router ensures that all electrical input signals are synchronized within a reasonable tolerance. For example, assuming a data rate of 10 Gbps and a bit time of 100 picoseconds, an acceptable synchronization tolerance of less than 10 picoseconds is provided. One way in which to equalize the propagation delays within optical cross-connect switch 38 is to provide nearly equal optical path lengths within each of the star power splitters 60A-60D and 62A-62D, and also in the fibers that connect star power splitters 60A-60D with star power splitters 62A-62D. Assuming the same 10-picosecond synchronization tolerance as was mentioned above and assuming fibers having a refractive index of approximately 1.5, the physical path lengths must be equal to within a tolerance of approximately 2 millimeters. Such a tolerance can be readily achieved. The propagation delay within the clock circuit 70 is set nearly equal to the other propagation delays by similarly meeting a physical path length tolerance of approximately 2 millimeters.

While particular embodiments of the invention have been shown and described, numerous variations and alternate embodiments will occur to those skilled in the art. Accordingly, it is intended that the invention be limited only in terms of the appended claims.

What is claimed is:

1. A router circuit having a plurality of electrical input signals comprising:
an electrical-to-optical converter for changing the plurality of electrical input signals into a plurality of optical input signals;
a mixing circuit coupled to the electrical-to-optical converter, said mixing circuit generating a plurality of substantially identical composite signals corresponding to the plurality of optical inputs, said composite signals comprising at least a portion of each of said plurality of optical signals;
a plurality of optical bandpass filters coupled, respectively, to each one of said plurality of composite signals, said plurality of bandpass filters passing a portion of said optical signal to form a plurality of filtered signals, and
an optical-to-electrical converter circuit coupled to the plurality of bandpass filters, said optical-to-electrical converter converting said plurality of filtered optical signals into a plurality of respective electrical output signals.

2. A router circuit as recited in claim 1 wherein said plurality of bandpass filters comprises a respective plurality of center wavelengths.

3. A router circuit as recited in claim 2 further comprising a control circuit coupled to said electrical-to-optical converter, wherein said electrical-to-optical converter comprises a plurality of electrical-to-optical converters, said control circuit selecting a respective plurality of electrical-to-optical converter wavelengths in response to said plurality of bandpass center wavelengths.

4. A router circuit as recited in claim 3 wherein said plurality of wavelengths of the electrical-to-optical converter is tunable.

5. A router circuit as recited in claim 2 wherein said plurality of center wavelengths of the plurality of bandpass filters is tunable.

6. A router circuit as recited in claim 1 wherein said electrical-to-optical converter comprises a plurality of electrical-to-optical converters.

7. A router circuit as recited in claim 1 wherein said mixing circuit comprises at least a first plurality of mixers cross coupled with a second plurality of mixers.

8. A router circuit as recited in claim 1 wherein said electrical-to-optical converter comprises a modulated tunable laser having a programmed wavelength.

9. A router circuit as recited in claim 8 wherein said tunable laser is coupled to a control circuit and a temperature sensor, said control circuit tuning said laser in response to said temperature sensor to maintain the programmed wavelength.

10. A router circuit as recited in claim 1 further comprising a clock circuit, said clock circuit comprising a clock electrical-to-optical converter, an optical delay line and an optical-to-electrical converter.

11. A router circuit as recited in claim 10 wherein said optical delay line comprises an optical fiber.

12. A router circuit as recited in claim 1 wherein said optical-to-electrical converter comprises a photodiode.

13. A router circuit as recited in claim 1 wherein said mixing circuit comprises a passive star power splitter.

14. A satellite system comprising:
said electrical inputs comprising RF inputs;
a router circuit as recited in claim 1.

15. A satellite system as recited in claim 14 further comprising a buffer circuit receiving said plurality of RF signals, said buffer circuit synchronizing said electrical input signals within a predetermined tolerance before the router

16. A router circuit comprising:
an electrical-to-optical converter changing electrical inputs into optical signals;
a first mixing circuit coupled to a first group of said plurality of optical signals, said first mixing circuit having a first output and a second output, said first output and second output each having a first composite signal comprising said first group of optical signals;
a second mixing circuit coupled to a second group of said plurality of optical signals, said second mixing circuit having a third output and a fourth output, said third output and fourth output each having a second composite signal comprising said second group of optical signals;
a third mixing circuit coupled to said first and third outputs, said third mixing circuit generating a third composite signal comprising said first composite signal and said second composite signal;
a fourth mixing circuit coupled to said second output and fourth output, said fourth mixing circuit generating a fourth composite signal comprising said first composite signal and said second composite signal;
a bandpass filter circuit coupled to said third mixing circuit and said fourth mixing circuit, said bandpass filter circuit comprising a first and a second optical bandpass filter, said first bandpass filter coupled to said third composite signal for generating a first optical output and a second bandpass filter coupled to said fourth composite signal for generating a second optical output; and
an optical-to-electrical converter circuit coupled to said bandpass filter circuit for converting said first optical output to a first electrical output and said second optical output to a second electrical output.

17. A router circuit as recited in claim 16 wherein said electrical-to-optical converter comprises a modulated tunable laser.

18. A router circuit as recited in claim 17 wherein said tunable laser is coupled to a control circuit and a temperature sensor, said control circuit controlling said laser in response to a desired router operation and said temperature sensor

19. A router circuit as recited in claim 16 further comprising a clock circuit, said clock circuit comprising a clock electrical-to-optical converter, an optical time delay circuit and an optical-to-electrical converter.

20. A router circuit as recited in claim 16 wherein said optical-to-electrical converter comprises a photodiode.

21. A router circuit as recited in claim 16 wherein said first mixing circuit and said second mixing circuit comprise a respective first star power splitter and a second star power splitter.

22. A method of operating a routing circuit comprising:
converting a plurality of electrical signals to a respective plurality of modulated optical signals;
coupling the plurality of modulated optical signals to a cross connect switch;
forming a plurality of composite signals at a plurality of outputs of the cross-connect switch, said plurality of composite signals composed of said modulated optical signals;
converting each of the composite signals into an electrical output signal corresponding to a portion of said modulated optical signals.

23. A method as recited in claim 22 further comprising synchronizing the output signal using a clock signal.

24. A method as recited in claim 22 wherein synchronizing comprises delaying the clock signal an amount corresponding to a delay of the cross-connect switch, to obtain a delayed clock signal.

25. A method as recited in claim 22 wherein converting a plurality of electrical signals to a respective plurality of modulated optical signals comprises modulating a respective plurality of diode lasers, each of which is tuned to the center wavelength of a bandpass filter.
